(19) United States
(12) Patent Application Publication
(10) Pub. No.: US 2014/0055315 A1
(43) Pub. Date: Feb. 27, 2014

(54) Wireless Telephone Coupled Antenna

(71) Applicants: Henry Cooper, Murrietta, CA (US); Sheng Peng, Lynnwood, WA (US)

(72) Inventors: Henry Cooper, Murrietta, CA (US); Sheng Peng, Lynnwood, WA (US)

(21) Appl. No.: 14/010,413

(22) Filed: Aug. 26, 2013

Related U.S. Application Data
(60) Provisional application No. 61/693,110, filed on Aug. 24, 2012.

(51) Int. Cl. H01Q 1/50

(52) U.S. Cl. CPC H01Q 1/50
USPC 343/850

(57) ABSTRACT

An auxiliary antenna for a RF communicating computing device such as a smartphone or pad computer or laptop computer, is provided for enhancement of the RF transmit and receive capabilities of the computing device. The antenna is engaged using mutual coupling of the antenna to an input point or feed line or antenna element of the computing device by registered placement on or adjacent an exterior surface of the computing device. The registered engagement can be provided by inclusion of the auxiliary antenna in a protective or decorative surrounding case, or use of an applicable antenna on a dialectic and a pattern configured to only engage the proper surface of the computing device.

This application claims priority to U.S. Provisional Patent Application No. 61/693,110 filed on Aug. 24, 2012, and is included herein in its entirety by this reference.

### BACKGROUND OF THE INVENTION

1. Field of the Invention

The present invention relates generally to cellular telephones. More particularly the invention relates to an antenna device with one or a combination of a capacitive patch and inductive strip configurations for a symbiotic coupling to an existing antenna of a conventional cellular telephone for improving the transmission and reception of radio frequency communications to and from the cellular device.

2. Prior Art

Electronic device's such as smart phones, cell phones, laptops, tablets, and the like conventionally communicate with cellular towers, computer networks, internet modems, bluetooth, etc. via wireless radio frequency (RF) communication. This is accomplished through the employment of one or a plurality of antennas having radiator elements electronically integrated into the devices and configured to the task of transmitting and receiving, at pre-determined wavelengths, for the desired purpose.

The frequency band of communication can vary widely depending on the type of wireless communications being implemented in a wireless grid, such as cellular or WiFi or digital communications for emergency services. The system requirements for gain and individual employed frequencies can also vary depending on the FCC and client's needs. Also, a horizontal, vertical, or circular polarization scheme that may be desired to either increase bandwidth or connections.

However, the type of wireless communication provided by a grid or other source is only useful when the receiving device is able pick it up. Even with the advancements in the technology of smart phones and other devices, users often continue to experience poor cellular reception. This is contributed wholly or in part, by the availability and quality of cellular grids in a certain area provided by cellular communication firms, as well as the quality of the antenna of the receiving device itself. Cellular providers are often limited to the quantity and location of which a cellular grid can be built. These grids are often considered eye-sores in neighborhood and public areas. Therefor adding more or constructing larger grids, to provide improved cellular reception to customers is often limited.

Further, manufacturing cell phones and other electronic devices for RF communication with stronger and better antennas will tend to drive cost up for the manufactures which is translated to undesirable increased cost to the customer. In addition, retrofitting or replacing existing antennas of these devices, with better antennas, must be done carefully and correctly and with vast knowledge of the inner workings of electronics. This is not easily accomplished by the average consumer who merely want better cell phone reception.

There has not been a highly signal sensitive and easily constructed, relatively small antenna for employment with electronic devices such as cell phones, smart phones, laptops, tablets, and the like. As such, there is a continuing unmet need for an antenna device for improving RF reception and transmission for electronic devices employing RF communication means. Such a device should advantageously be configured for a symbiotic coupling to the existing antenna of the electronic device. Further, such a device should be easily engageable to an electronic device such as through the provision of a cover or case having the antenna device engaged thereon which engages over or onto an electronic device.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device herein disclosed and described provides a solution to the shortcomings in prior art and achieves the above noted goals through the provision of an antenna device which is uniquely shaped and configured to provide a symbiotic coupled engagement to an electronic device employing RF communication means, such as a smart phone. In accordance with a first preferred mode, the device includes a radiator element, feed line, ground plane, and one or a combination of a capacitive patch or inductive strip portions for providing a coupling to the transmission and reception feedpoint of the electronic device to improve the transmission and reception capabilities of the electronic device at the intended frequency band.

The radiator element of the instant invention is based upon a planar antenna element formed by printed-circuit technology. The antenna is of two-dimensional construction and is formed on a dialectic substrate of such materials as MYLAR, fiberglass, REXLITE, polystyrene, polyamide, TEFLON, fiberglass or any other such material suitable for the purpose intended. The substrate may be flexible whereby the antenna can be rolled up for storage and unrolled into a planar form for use. Or, in a particularly preferred mode of the device herein, it is formed on a substantially rigid substrate material in the planar configuration thereby allowing for components that both connect, and form the resulting rigid antenna structure.

The antenna radiator element, capacitive patch or inductive strip, ground plane, and feed line formed on the substrate, can be any suitable conductive material, as for example, aluminum, copper, silver, gold, platinum or any other electrical conductive material suitable for the purpose intended. The conductive material forming the element is adhered to the substrate by any known technology.

In a particularly preferred embodiment, the antenna radiator element, capacitive patch, and feed line conductive materials are coated on a first side of the substrate. The formed radiator element has the general appearance of a meander line antenna element which communicates with the capacitive patch via a microstrip transmission line or “feed line”. The feed line is preferably formed to 50 Ohm impedance, however can be of any construction and configuration as needed for the intended purposes set forth in this disclosure.

On the opposite surface of the substrate from the formed radiator element, a ground plane is engaged at a position substantially covering the area of the feed line of the first surface of the substrate. The positioning and configuration of the ground plane provides a means to block outside RF interference from interrupting a signal transmitting down the feed line. This aspect is especially desired when the device is employed with a smart phone or other electronic device, in order to block a ground coupling of the users hand with the antenna which conventionally occurs when holding the electronic device. While holding an electronic device employing RF communication, the users hand will act as a symbiotic ground plane and interrupt signals through the existing signal communication means, and the ground plane of the present invention solves this problem.

The location and width of the feed line and connection, the size and shape of the capacitive patch and ground plane, and the shape and configuration of the meander line radiator element may be of the antenna designer's choice for best results for a given use and frequency. However the current mode of the radiator element, feed line, capacitive patch, and ground plane as depicted herein, with the connection point shown, is especially preferred. Of course those skilled in the art will realize that various aspects of the invention be adjusted to increase gain in certain frequencies, improve impedance matching, or for other reasons known to the skilled, and any and all such changes or alterations of the depicted radiator element as would occur to those skilled in the art upon reading this disclosure are anticipated within the scope of this invention.

In a preferred as used mode of the invention, coupling of the device to a cellular telephone is accomplished by positioning the patch at or near the location of the transmit and receive signal feed or pickup-point on the back surface of the phone. In this manner the device achieves a symbiotic relational coupling to the signal feedpoint of the phone, and therefor the meander line radiator element can now be employed to transmit and receive RF signals to the phone. Selection and tuning of the device is accomplished by probing the phone at various locations using various configurations of the invention to find the optimum coupling point. Once the optimum point is established, the radiator element is then selectively optimized and tuned to the desired frequency band.

Further, the spacing of the device from the surface of the phone is selectively chosen for further optimization and fine tuning. Preferably, the height or spacing of the device from the phone is in the range of 0.005 and 0.5 inches, however can vary depending on parameters determined by the designer.

In additional preferred modes, the device can comprise a low noise amplifier (LNA) for boosting the signal from meander line radiator element. The LNA preferably communicates between the radiator element and feed line and may be powered one or a combination of a battery, thermoelectric generator, piezoelectric generator, or the like.

In at least one preferred mode, the operative employment of the device with an electronic device is provided by a case or cover which is engageable over the existing electronic device. In use, the antenna device of present invention is pre-tuned for RF communication a specific electronic device, such as an IPHONE, and the optimum location and orientation also predetermined. The device is then engaged to the case or cover at a specified location, such that, when the user simply engages the cover or case onto their phone, the patch and antenna element of the device will be at the optimum location for coupling to the existing feed or radiation-point of the phone.

Still further, the case or cover can employ a plurality of antenna devices, each configured for different RF communication, such as cellular, wifi, bluetooth, and so forth. Each antenna will be pre-positioned on the case and tuned to the specified frequency band, such that all the user must do is engage the case to their phone. Therefor, the user is provided with a simple yet novel means to improve transmission and reception capabilities of their smart phone or other electronic device across a plurality of frequency bands.

In yet another preferred mode, the device is providable to the user in a kit, comprising one or a plurality of cases having removably engageable antenna elements. The user then can selectively engage the desired antenna element. The case may include registering markings for showing the user where the optimum locations are for engaging the antenna elements.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

It is an object of the invention to provide an antenna device which can be coupled to the existing antenna of an electronic device for improving transmission and reception capabilities of the electronic device.

It is an object of the invention to provide a coupled antenna which is tuned for a specific use and frequency band.

It is an object of the invention to provide a user engageable case employing the antenna device for easy coupling and employment.

These and other objects, features, and advantages of the invention will be brought out in the following part of the specification, wherein detailed description is for the purpose of fully disclosing the invention without placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 shows a front view of a particularly preferred mode of the device depicting the radiator element, feed line, and substantially circular capacitive patch formed on a non-conductive substrate.

FIG. 2 is a rear view of the device of FIG. 1 showing the ground plane.

FIG. 3 is again a front view of the device of FIG. 1 with the ground plane of the rear surface shown as dashed lines.

FIG. 4 shows a view of another preferred mode of the device having an alternatively configured radiator element, showing the ground plane of the rear surface in dashed lines.

FIG. 5 shows a view of yet another preferred mode of the device having an alternatively configured radiator element and smaller capacitive patch, showing the ground plane of the rear surface in dashed lines.

FIG. 6 shows a view of still another preferred mode of the device having an alternatively configured radiator element and substantially square capacitive patch, showing the ground plane of the rear surface in dashed lines.

FIG. 7 shows a view of still another preferred mode of the device having an alternatively configured radiator element and substantially elongated rectangular capacitive patch, showing the ground plane of the rear surface in dashed lines.

FIG. 8 shows a view of the device formed as a planar cover and being engaged to a cellular phone and employing a dialectic material to tune the spacing of the antenna of the device from the phone.

FIG. 8a shows a view of the device engaged upon a surrounding cover style case, and being slidably engaged to a cellular phone within a formed cavity and employing a dialectic material to tune the spacing of the antenna of the device from the phone antenna.

FIG. 9 depicts a view of a preferred as used mode of the invention showing a plurality of antenna devices engaged to case or cover component at the optimum position, which is determined first, so it can be registered with the antenna in or on a smart phone device protective case or cover.

FIG. 10 shows another preferred mode of the device employing a low noise amplifier configuration.

FIG. 11 depicts a pattern providing a means to register the device upon a smartphone or smart device during engagement.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

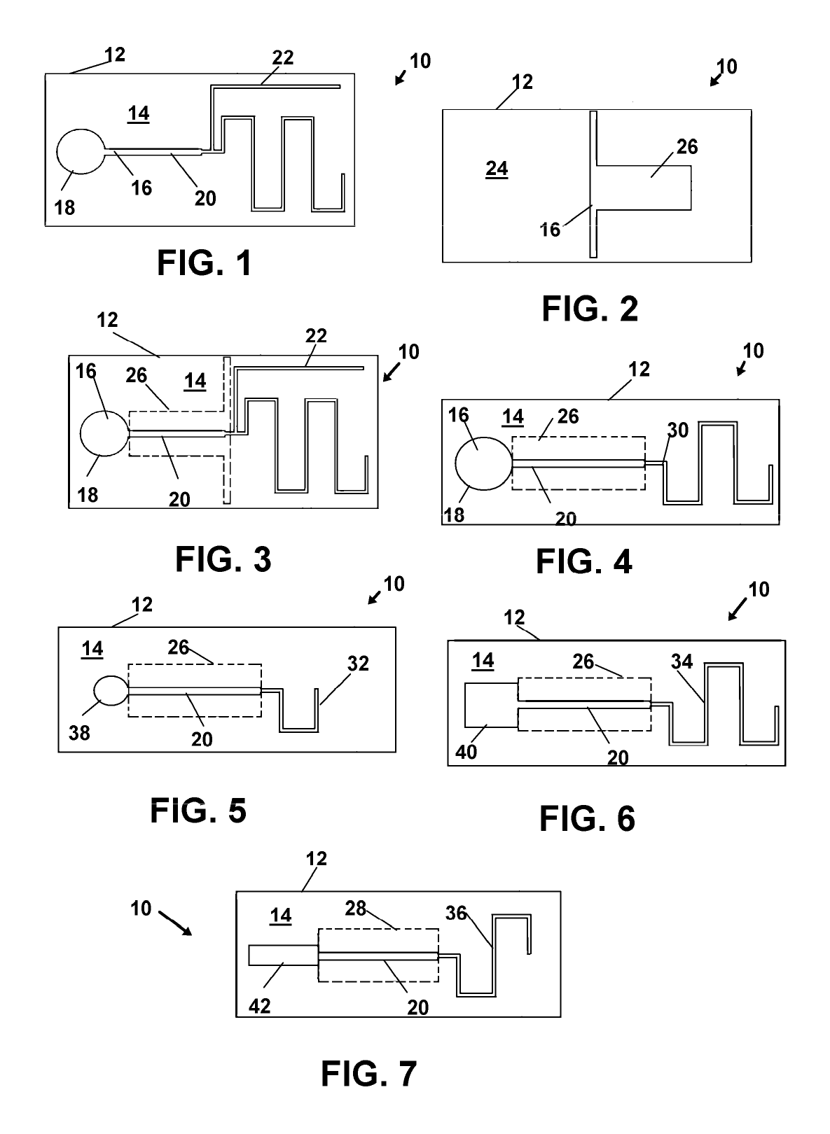

Now referring to drawings in FIGS. 1-11, wherein similar components are identified by like reference numerals, there is seen in FIG. 1 the antenna device 10 intended for a symbiotic coupling to a cellular telephone for improving transmission and reception characteristics. This coupling is best achieved by first using RF or other sensing means such as an anechoic chamber to ascertain the ideal coupling point on the smartphone or pad or similar device, so the feedpoint or capacitive match 18 on the antenna is positioned on the protective casing in a registered engagement with the feedpoint, to maximize both signal gain on reception, but especially signal gain on transmission since the phone, pad, or other smart device usually has a much lower transmission signal strength than for example a cell tower.

This feed point has been found to frequently be a perpendicular line normal to a center point where the factory or OEM antenna has a connection on the motherboard or circuit board inside the phone. However, it can also be adjacent a point along the length of the factory antenna. During the determination of a feedpoint for registration with the attached antenna, a visual determination of the OEM antenna connection point may be carried out, and an inline positioning of the feed point the anechoic chamber to ascertain the ideal coupling point on the smartphone or pad or similar device, so the feedpoint or capacitive patch 18 is determined as a registered position for the position of the capacitive patch 18 upon the case or casing to be engaged. Thereafter testing in an anechoic chamber or the like is carried out to determine broadcast and reception patterns relative to this registered positioning and a fine tuning of the portioning of the feed point to capacitive patch 18 is carried out.

Also once the registered position for the capacitive patch 18 is determined, the antenna is tested for distance of the capacitive patch from the feedpoint on the smart device through the plastic or polymeric material having a dielectric constant substantially the same as that which will form the engaged case or casing upon the smart device such as a smartphone or pad computer. Again, such testing may be done on an antenna range, however the preferred mode is using an anechoic chamber due to the low transmit power of the smart devices and high amount of noise on an outside range. With the distance of separation determined, the registered positioning of the capacitive patch 18 with the engaged smart device for both alignment with the factory circuit board and distance of separation therefrom within or on the plastic or polymeric material providing the mount.

The auxiliary antenna device 10 itself is formed on a substrate 12 which as noted is non conductive and may be constructed of either a rigid or flexible material such as, MYLAR, fiberglass, REXLITE, polystyrene, polyamide, TEFLON fiberglass, or any other such material which would be suitable for the purpose intended. During formation, a first surface 14 is coated with a conductive material 16 by microstrip-line or the like or other metal and substrate construction well known in this art.

Any means for affixing the conductive material 16 to the substrate 12 is acceptable to practice this invention. The conductive material 16 as for example, include but are not limited to aluminum, copper, silver, gold, platinum or any other electrical conductive material which is suitable for the purpose intended. As shown in FIG. 1 the surface conductive material 16 on first surface 14 is coated to form the capacitive patch 18, feed line 20, and meander line type radiator element 22.

On the opposite surface 24 of the substrate 12 shown in FIG. 2, a ground plane 26 extends the area between the capacitive patch 18 and the radiator element 22 and at least covering the area of the feed line 20 of the first surface 14 of the device 10. FIG. 3 shows again the front surface 14 of the device 10 better depicting the location of the ground plane 26 of the opposite surface 32 in dashed lines. The ground plane 26 is provided as a type of interference shield, to block any interference with the signal traveling down the feed line 20. This is described in more detail shortly below.

FIG. 4-FIG. 7 show views of other particularly preferred modes of the device 10 depicting various examples of alternative configurations of the radiator element and capacitive patch 18. It is firstly noted that those skilled in the art will recognize that the configuration, size, and other aspects of the capacitive patch 18, feed line 20, and radiator element can be of the designers choice for fine tuning the device 10 for a specific use and to maximize gain for both transmission and reception as noted above during testing. As such the following examples are provided as merely possible alternatively preferred configurations and should not be considered limiting. Additional modifications, changes, and alterations recognized by those skilled in the art can be made within the scope of this invention, and are anticipated.

FIG. 4 shows another preferred configuration using a meander line type radiator element 30. It is noted that radiator element of the antenna device 10 can be of any type suitable for the intended purpose and should not be considered limited by the depictions. However, because of the disclosed meander line radiator elements 30 performs so well and across the desired bandwidth, the current modes of the radiator elements as depicted in the figures herein, is especially preferred.

Of course those skilled in the art will realize that the size and shape of the segments in the used meander line may be adjusted to increase gain in certain frequencies by lengthening or shortening such, or for other reasons known to the skilled, and any and all such changes or alterations of the depicted radiator element as would occur to those skilled in the art upon reading this disclosure are anticipated within the scope of this invention.

FIG. 5 shows a mode of the device 10 employing a smaller sized capacitive patch 38, compared to that of FIG. 1. This may be preferred for the tuning purposes in a particular application. Also shown is an alternatively preferred meander line radiator element 32.

FIG. 6 shows yet another mode of the meander line radiator element 34, also showing a substantially square capacitive patch 40. Again, those skilled in the art will realize that the size and shape of the capacitive may be adjusted for tuning the device to certain frequencies or for other reasons known to the skilled, and any and all such changes or alterations of the depicted patches as would occur to those skilled in the art upon reading this disclosure are anticipated within the scope of this invention.

FIG. 7 show still yet another mode of the radiator element 36, as well as a preferred elongated substantially rectangular patch 42.

The device 10 engages with the smart device such as a smartphone or pad computer by a symbiotic coupling to the existing antenna, or the feed of such, to the internal cellular telephone or broadcast component. Such components are usually stationed within the casing of a smart phone or the like. So positioned in the noted registered engagement position on the exterior case or casing, the device 10 improve antenna reception and transmission without a direct contact using mutual coupling.

In use, the mutual coupling of the radiator element of the antenna device 10 with a smart device such as a smartphone, pad computer, or cellular telephone, or other wireless device, is accomplished by the noted registered positioning of the capacitive patch 18 portion at or near the location of the transmit and receive signal feed, or pickup-point of the wireless enabled device, to achieves a symbiotic or mutual coupling with the signal feedpoint of the phone or wireless enabled device.

As such, the radiator element 22 is now coupled to provide a means for enhanced transmission and reception of RF signals to and from the phone or wireless enabled device. Selection and tuning of the antenna device 10, as noted, is accomplished by probing the phone at various locations using various configurations using RF sensing electronic equipment such as an anechoic chamber to find the optimum coupling point, and thereafter endeavoring to engage the device 10 in a registered positioning with the case or casing that is to engage the smartphone or smart device. Once the optimum point is established, the radiator element 22 can also be selectively optimized and tuned to the desired frequency band, and enabled with the proper sized coupling patch 18 and feed line 20 which are two components which provide means for adjustment of the performance of the device 10 by adjusting the area or size of the patch 18 and length of the feed line 20, to enhance the broadcast and receive RF signals.

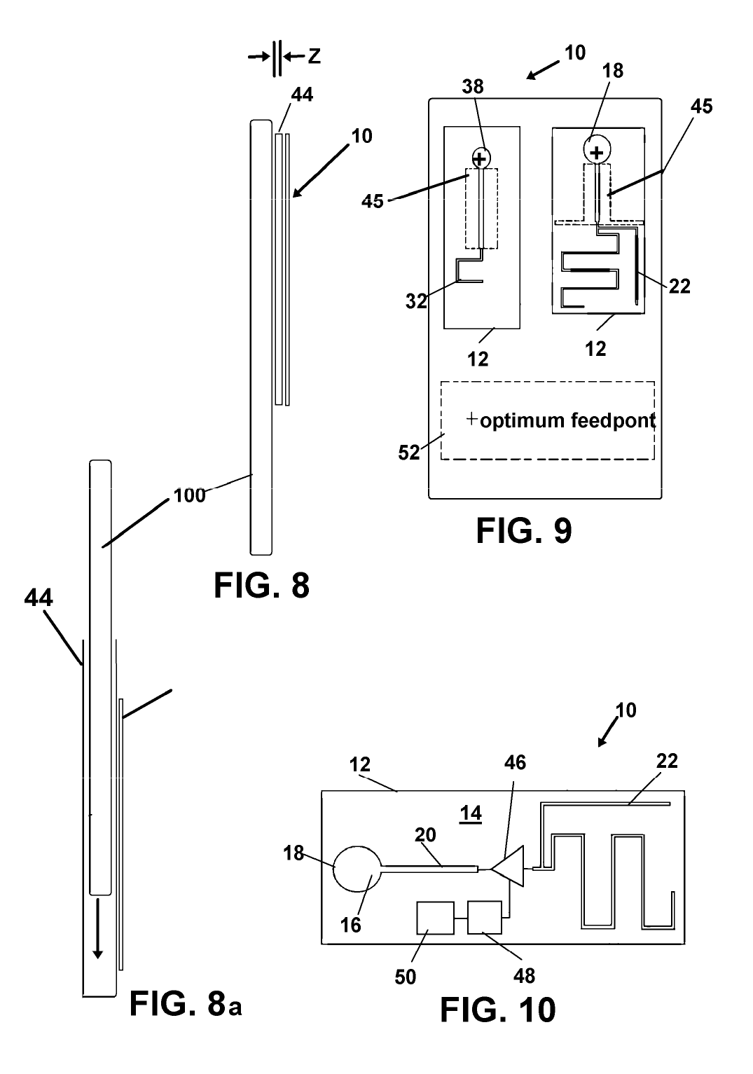

As shown in FIG. 8, additional tuning of the device 10 is provided by the spacing of the device 10 a distance ‘Z’ from the case covering the phone or smart device. This may be selectively chosen for further optimization and fine tuning. Preferably, the height or spacing ‘Z’ of the capacitive patch 18 of the device from the phone 100, is in the range of 0.005 and 0.5 inches, however can vary depending on parameters determined by the designer and chamber testing and the dialectic constant of the material forming the intended protective or decorative case in which the device 10 is positioned in the registered engagement to maximize antenna coupling. This spacing is preferably accomplished through the employment of a dielectric material for the planar section of the case 44 as a dialectic spacer engaged between the antenna element of the device 10 and the phone 100 antenna. In FIG. 8a is shown the case 44 formed as a cover for the phone 100 and having an interior cavity adapted to align the phone 100 antenna with the auxiliary antenna element of the device 10 such as those in FIGS. 1-7.

In the preferred as-used mode of FIG. 9, the operative employment of the device 10 for engagement with a cellular telephone type smart phone, or other wireless-enabled device such as a pad computer or laptop computer, is provided by a surrounding planar cover 44 area in a planar covering section or as a surrounding protective or decorative case as in FIG. 8a. The planar cover 44 or case is engageable in a registered position over the side surface of the existing electronic device so as to position the coupling patch 38 over the prime feedpoint of the interior antenna for the phone 100.

In use, the antenna device 10 of present invention is pre-tuned for RF communication and mutual coupling with a specific electronic device, such as an IPHONE, and the registered engagement in the optimum location and orientation which is also predetermined, as mentioned above, and the device 10 engaged with the protective of decorative case which is formed to easily achieve a registered engagement once mounted and optimum coupled antenna engagement.

In use, where not actually engaged to or within the case 44 material, the device 10 having a substrate 12 with the desired antenna element thereon, may be pulled from a kit or package, and the device 10 is then registered in an engagement to the case 44 or cover in a position corresponding to the specified optimum location for antenna coupling when engaged to the phone, such that, the user simply engages the cover or case 44 onto their phone, and the patch 18 or 38 providing the means for coupled engagement with the interior antenna feed is operatively registered for an engagement at the optimum location for a coupling to the existing feed or radiation-point of the phone. The shape, size, and configuration of the case 44 may be adapted to allow for easy achievement of this registered engagement.

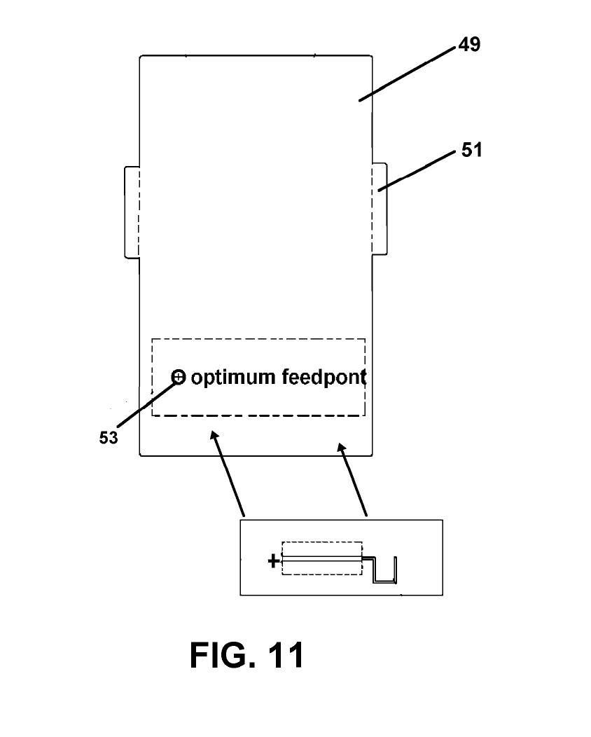

The device 10 as shown in FIG. 11 may be provided with a paper or plastic pattern 49, for temporary engagement with the smart device by the user. The pattern 49 is formed to engage on or with a single surface of an RF communicating commuting device such as a specific smartphone, pad computer, or other device where the antenna device 10 is to be engaged. The pattern is formed to only engage the intended smartphone or pad computer or other device, in a fixed or registered position, on only one surface of multiple surfaces, to provide a means for identifying or marking the target spot 53 for positioning of the patch 18 when the device 10 is engaged to achieve a registered engagement. In the registered engagement, the positioning of the patch 18 at the identified target position on the side surface, will achieve the antenna coupling required for the antenna device 10 to enhance reception and transmission of the RF communicating computing device. As noted, axial alignment shown in dotted line in FIG. 9 and FIG. 11, for the antenna device 10 for installation, can be provided using a cut-out or aperture in the pattern 49, such as inside the dotted line, contouring of the pattern 49 in three dimensions, or indicia on the pattern 49, showing the proper axial alignment and alignment with the single surface intended. Thus both the axial alignment and registered engagement can be provided by the pattern 49 using one or a combination of indica on the pattern 49, contouring of the pattern 49, or apertures formed in the pattern 49.

The patterns 49 are determined by pretesting models of smartphones, cellphones, pad computers and the like, to determine the optimum positioning of the patch 18 of the device. The patterns 49 would be cut to only engage in one manner, with the target smart device, by a contouring or shaping or providing folding tabs 51 or the like, as means for registering the pattern 49, to only engage in one fashion with one exterior surface, of the intended device for mounting of the device 10. A target area 53 for marking, or, a cut out along the interior of the pattern, will be provided to allow the user to easily ascertain the correct positionings of the patch 18 to achieve the coupling of the antenna device 10 to the smartphone or pad computer or laptop.

Still further, as can also be seen in the FIG. 9, the case or cover 44 can be fitted with a plurality of antenna devices 10, each configured for different RF communication, such as cellular, wifi, bluetooth, high gain, wideband, and so forth. Each capacitive or coupling patch 18, and 38 will be operatively positioned in on substrate 12 to achieve a registered engagement to optimally couple the interior phone antenna feed to the antenna on a planar or surrounding case 44 which is optimized for the specified frequency band, such that all the user must do is engage the planar or surrounding case 44 to their phone.

Therefor, the user is provided with a simple yet novel means to improve transmission and reception capabilities of their smart phone or other electronic device across a plurality of frequency bands. Further, engagement using provided means for registered engagement insures performance will be maximized.

In additional preferred modes of the invention shown in FIG. 10, the device 10, whether on a planar case 44 or planar section of a surrounding planar case 44 additionally may include a low noise amplifier (LNA) 46 for amplifying the electronic signal from the antenna element 22, such as the depicted meander line radiator element, before the signal reaches the coupling component or patch 18 providing the coupling to the phone's interior antenna or feed. The LNA 46 preferably communicates between the radiator element 22 and feed line 22 to increase the received signal and minimize noise.

A ground plane 45 is preferably positioned above the feed line area in-between the feed line and exterior of the phone 100, to eliminate a coupling to the user's hand when holding the phone. This ground plane 45 provides a means to minimize interference caused by the user's body and especially hand, with the unamplified signal.

It is noted that the provision of an LNA 46 can be employed for any mode of and configuration of the device 10 herein, and should not be considered limited by the depiction. The LNA 46 is preferably powered by an onboard means for electrical power generation 50 coupled with a power storage battery 48. The electrical generating means can be one or a combination of a thermoelectric generator, configured to engage a portion of the wireless device which radiates heat, a piezoelectric generator which generates electrical current during movements of the phone by the user, a solar cell, or other means to generate the electrical current sufficient to charge the onboard battery 48 which will run the small microprocessor handling antenna switching and beam steering as well as a low noise amplifier LNA 46. Further the battery 48 can be any battery known in the art suitable for the intended purpose and could also have a connection with the internal battery of the phone to power the LNA 46 and/or microprocessor and switching.

In yet another preferred mode, device 10 is providable to the user in a kit, comprising one or a plurality of cases 44 and one or a plurality of removably engageable antenna elements 22 configured for varying types of reception such as data, voice, video, television, and even satellite with the correct configuration of antenna element. The pattern 49 customized for the intended smartphone, pad computer, or other device for which the antenna elements 22 of the antenna device 10 herein are to be engaged, and be provided if the devices 10 are to simply be engaged to the outside covering of the smart phone or pad computer or the like.

Also in this mode, a case 10 or cases may be adapted for a cooperative, operative registered engagement with the board carrying the antenna element 22 for the intended broadcast or reception. For instance a user in the outskirts of a city where reception is sparse may wish to engage a high gain antenna to try and enhance signal. Conversely a user in the city where signals are strong and plentiful, may wish to engage an antenna element 22 configured for a broader footprint for reception to give them more broadcast point options, or, an antenna element 22 which is wideband and configured for both cellular and Wifi communications to enhance both.

In use, the antenna elements 22 will be available in a kit featuring a plurality of elements 22 having configurations adapted to enhance a band, reception area, gain, enhanced frequency range, and the like, such as those in FIGS. 1-7. From the kit, the user then can selectively engage the desired antenna element 22 to the case 44 for a desired frequency band or RF communication enhancement. The case 44 may include indicia designating registration markings 52 for showing the user the correct location and orientation of the antenna element 22, to properly position the coupling patch 18 or 38 for proper coupled engagement of the phone interior antenna to the antenna element 22 of choice. The indicia might also be a recess, in the cover, or a pocket for insertion of the antenna element 22 and surrounding dialectic planar surface. The axial alignment can be shown by a drawing of the device 10 or a cut-out in the pattern 49 (FIG. 11). Thus, should new uses become available for a smartphone by a firmware or circuit upgrade, such as broadcast television, the user can engage the antenna element 22 to the case 44 which is adapted for such registered operative engagement and enjoy the new service.

In all modes herein, the device 10 may be provided to users as a do-it-yourself component, where the appropriate configured antenna device 10 is provided with the appropriate pattern 49 which is configured to provide a target position for the coupling component or capacitive patch 18 to place the device 10 in a registered engagement with the smartphone or pad computer or other device to which the pattern 49 is specifically configured. The pattern 49 and the antenna device 10 would be configured for the specific smartphone or pad computer or the like, and provided to the user with appropriate instructions to mate the pattern 49 to the single side of the intended device for which it is configured to align. When so mated, to mark or otherwise identify the target position for the patch 18 acting as the antenna coupling component, along the proper noted axial alignment for the device 10. Finally, to engage the antenna device 10 with the patch 18 or coupling component, positioned upon the target position and with the device 10 axial alignment correctly placed as identified on the pattern 49. Engagement can be by adhesive such as a peel and stick type adhesive back.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed:

1. An auxiliary antenna for a RF communicating computing device such as a smartphone or pad computer or laptop computer, comprising:
an antenna element engaged with a feed line;
a coupling component engaged with said feed line;
said antenna element, feed line and coupling component operatively engaged to a planar dialectic section;
said planar dialectic section configured for a registered engagement with said smartphone, pad computer, or laptop computer;
said registered engagement positioning said coupling component adjacent an electrically communicating component of said RF communicating computing device; and
said positioning of said coupling component by said registered engagement forming a coupling of said antenna element with said RF communicating component device.

2. The auxiliary antenna of claim 1, additionally comprising:
said planar dialectic section being a planar portion of a surrounding case configured to engage around said RF communicating computing device.

3. The auxiliary antenna of claim 1, additionally comprising:
an adhesive positioned upon said planar dialectic section;
said adhesive providing means for engaging said dialectic to said RF communicating computing device to said registered engagement.

4. The auxiliary antenna of claim 3, additionally comprising:
a pattern, said pattern configured for a temporary engagement against a side surface of said RF communicating computing device;
said pattern having a means for identifying a target position for a placement of said coupling component; and
said pattern having means for identifying an axial alignment of said dialectic section and said antenna eminent with said side surface of RF communicating device, whereby a user can identify a proper positioning of said coupling component and an axial alignment of said antenna element to achieve said registered engagement.

5. The auxiliary antenna of claim 4, additionally comprising:
said pattern formed with means for alignment of said pattern solely with said side surface of a said RF communicating computing device having a plurality of said side surfaces.

6. The auxiliary antenna of claim 5, wherein said means for alignment of said pattern solely with one said side surface includes one or a combination of alignment means from a group including indica on said pattern, contouring of said pattern, and apertures formed in said pattern.

7. The auxiliary antenna of claim 2 additionally comprising:
said auxiliary antenna positioned upon or within said planar portion of said surrounding case, such that when said RF communicating computing device is positioned within said surrounding case in an engaged position, said registered engagement is achieved positioning said coupling component adjacent said electrically communicating component of said RF communicating computing device with said antenna element in an axial alignment with said RF communicating computing device.

8. The auxiliary antenna of claim 7 additional comprising:
said antenna element being a meander line antenna having a plurality of segments forming said meander line, each of said segments of a length adapted for an RF frequency employed by said RF communicating computing device.

9. The auxiliary antenna of claim 6 additional comprising:
said antenna element being a meander line antenna having a plurality of segments forming said meander line, each of said segments of a length adapted for an RF frequency employed by said RF communicating computing device.

10. The auxiliary antenna of claim 2 additional comprising:
a low noise amplifier engaged between said antenna element and said coupling component;
said low noise amplifier powered by a rechargeable battery;
a thermoelectric generator positioned adjacent a heat radiating component of said RF communicating computing device; and
said thermoelectric generator providing an electric charge to said battery during periods in which said heat radiating component radiates said heat.

11. The auxiliary antenna of claim 4 additional comprising:
a low noise amplifier engaged between said antenna element and said coupling component;
said low noise amplifier powered by a rechargeable battery;
a thermoelectric generator positioned adjacent a heat radiating component of said RF communicating computing device; and
said thermoelectric generator providing an electric charge to said battery during periods in which said heat radiating component radiates said heat.
